(19) United States
(12) Patent Application Publication
(10) Pub. No.: US 2008/0047899 A1
(43) Pub. Date: Feb. 28, 2008

(54) Gradient liquid chromatography enhancement system

(75) Inventors: Dale A. Davison, Greenwood, NE (US); Mikael E. Mahler, Lincoln, NE (US); Veronica D. Thomason, Lincoln, NE (US); John J. Urh, Matthews, NC (US); David Trail, Waverly, NE (US)

Correspondence Address: VINCENT L. CARNEY LAW OFFICE, P.O. BOX 80836, LINCOLN, NE, 68501-0836, US

(73) Assignee: Teledyne Isco, Inc., Lincoln, NE (US)

(21) Appl. No.: 11/508,812

(22) Filed: Aug. 23, 2006

(51) Int. Cl. B01D 15/08

(52) U.S. Cl. 210/656; 436/161; 700/273

(57) ABSTRACT

An isocratic gradient profile is inserted into a gradient profile during a flash chromatographic run when TLC indicates that it will be difficult to separate the component being purified from its closest impurity by a gradient. TLC is utilized to determine at least two retention factors with two significantly different solvent strengths for the same solvent system. The two or more retention factors are used to determine a solvent strength in which the retention factor of a target component and the retention factor of a closest impurity are within 0.8 of each other. The isocratic gradient profile is started when this solvent strength is reached during the gradient chromatographic run. It is ended when the earlier of four events occurs, which are: (1) the end of a second peak if a first peak is detected at an isocratic-gradient profile starting-solvent strength or within a predetermined starting tolerance of the isocratic-gradient profile starting-solvent strength detection; (2) the end of the first peak after the starting tolerance; (3) the detection of a peak during the isocratic gradient profile or isocratic segment run after the regular isocratic time period; or (4) an operator initiated termination of the isocratic gradient profile or isocratic segment run. The gradient profile then resumes and continues to the end of the run.

### BACKGROUND OF THE INVENTION

This invention relates to liquid chromatography and more specifically to techniques for providing enhanced gradient programs.

It is known to utilize TLC in the development and use of gradient programs or profiles. For example, TLC is used to determine one or more solvent strengths that provide good resolution for separating a component or components of a mixture before using column liquid chromatography to separate the component or components. In one prior art technique utilizing TLC to select a chromatographic profile, one or more retention factors is determined by TLC and used to determine a solvent strength for the start of a chromatographic run and a solvent strength for the termination of a gradient run. Once the starting and ending solvent strengths have been selected, the user can select any of several profiles that are known in the art for the gradient profile to be used in a column liquid chromatographic gradient program. One such system is described in Japanese patent 3423707B1. The prior art technique using TLC to design a chromatographic program has a disadvantage in that the program may not be as effective as it could be for the detection, separation or purification of the component or components even after an appropriate gradient profile is selected, and thus time and solvent may be unnecessarily wasted with an excessive number of trial runs.

In one prior art approach to purifying a component, an isocratic hold is applied upon the detection of the onset of a peak. This aids in removing impurities with a higher retention factor than the component being purified. However, it has the disadvantage of: (1) not aiding significantly in the removal of the impurities with a lower retention factor because the isocratic delay occurs too late for this purpose; and (2) under some circumstances not being as effective as desired in separating components with close retention factors.

### SUMMARY OF THE INVENTION

Accordingly, it is an object of the invention to provide a novel technique for chromatography.

It is a further object of the invention to provide a novel design for a flash chromatography system using TLC;

It is a further object of the invention to provide a novel technique for utilizing TLC information to improve column liquid chromatography.

It is a still further object of the invention to provide a novel technique for reducing the time and solvent needed to design a chromatographic program.

It is a still further object of the invention to provide a novel technique for reducing the time and solvent needed to design a chromatographic gradient profile.

It is a still further object of the invention to provide a novel technique of flash chromatography.

It is a still further object of the invention to provide a novel approach to utilizing TLC to aid in column chromatography.

It is a still further object of the invention to provide a novel technique for improving the purification of a component.

It is a still further object of the invention to provide a novel technique for determining when a chromatographic run can be made more effective by a special enhancement program.

It is a still further object of the invention to provide a novel technique for introducing a novel enhancement program when it is appropriate.

In accordance with the above and further objects of the invention, a solvent strength is selected that provides a separation-effective retention factor during at least a portion of a chromatographic program for a target component that is to be detected, purified or separated by column liquid chromatography. The solvent strength for the target component is selected with the help of TLC. In this specification, the phrase “separation-effective retention factor” means a retention factor determined by TLC for a chromatographic system including a specific solvent strength, stationary phase and mobile phase that provides good separation of a target component during a chromatographic run using an isocratic gradient profile or isocratic segment. It is one of the conditions needed for separation effective conditions In the preferred embodiment, the separation-effective retention factor is less than 0.3 although 0.333 is the most common separation-effective retention factor used in liquid chromatography in general. This definition is also applicable to any two components that are being separated from each other whether one is considered a target component or not.

In the preferred embodiment, the separation-effective retention factor is selected to separate the primary component, which may be either the target component or the closest impurity, from the other of the target component or the closest impurity during a chromatographic run (isolate the target component). It is determined by selecting a solvent strength lower than the one of the target component or closest impurity that has a retention factor closest to 0.333. It is often selected to be as low as one-half the solvent strength that provides a retention factor closest to 0.333 to the one of the target component or closest impurity. In this specification, the phrase, “target component” means a component of a sample or mixture that is the subject of liquid chromatography. It is one of the materials of interest and is sometimes referred to as the material of interest or target compound. It is the component that is to be identified, separated or purified. When considering any two TLC spots rather than the spots caused by a target component and the closest impurity, the primary component is the component of the mixture that has a retention factor closest to the preferred retention factor at a bracketing solvent strength.

In the preferred embodiment, a flash chromatographic system is operated to purify a target component using separation effective conditions to isolate the target component. In this specification the words “separation effective conditions” means the conditions that efficiently isolate the target component. In the preferred embodiment of this invention, the separation effective conditions are obtained by first determining the separation effective retention factor during the portion of the program that separates the target component from its closest impurity or impurities. However, this system may be used for many other liquid chromatographic separation, detection, identification or purification operations utilizing substantially the same procedures. In this specification, the phrase, “closest impurity” means a material that is not a target component and has a retention factor closest in value to the retention factor of the target component. It is a material for which separation occurs with chromatographic conditions that are the same as, overlapping with or slightly different from those that separate the target component so as to be likely to become a contaminant unless care is taken.

In the preferred embodiment, TLC is utilized to determine at least two retention factors with two significantly different solvent strengths using a selected solvent system for the target component and a selected stationary phase. The two or more retention factors are used to determine bracketing solvent strengths and separation effective conditions. In this specification, the phrase, “bracketing solvent-strength” means any solvent strength in which the retention factor of the target component and the retention factor of the closest impurity having a retention factor closest to the retention factor of the target component are within: (1) 0.8 of each other such as being in the range of 0.1 and 0.9 and preferably in the range of 0.2 and 0.8; and (2) are between 1.5 and 9.5. When considering any two TLC spots rather than the spots caused by a target component and the closest impurity, the bracketing solvent strength is a solvent strength in which both spots have retention factors within: (1) 0.8 of each other such as being in the range of 0.1 and 0.9 and preferably in the range of 0.2 and 0.8; and (2) are between 0.1.5 and 9.5.

The bracketing solvent strengths provide a range of solvent strengths that include the solvent strengths available for a satisfactory separation effective retention factor. By comparing the change in retention factors of the target component or of the closest impurity at two different bracketing solvent strengths, the benefit from using an enhanced isocratically modified gradient profile can be evaluated and a decision made as to modifying the gradient profile or using it without enhancement.

To determine if an enhanced isocratically modified gradient profile is beneficial, the target component and/or the closest impurity are tested for enhancement potential. The enhancement potential is used to determine if an enhanced isocratically modified gradient profile should be used or only the regular unmodified gradient profile. A positive enhancement potential means that an enhanced isocratically modified gradient profile should be used and a negative enhancement potential means that the regular unmodified gradient profile should be used. In this specification, the phrase, “negative enhancement potential” means the retention factor of the target component and closest impurity are significantly distant from each other with different ones of the bracketing solvent strengths for a desired separation, identification or purification. Significantly distant in this definition means a gradient curve create suitable resolution without the need of a separation with an isocratic curve or segment of a profile. The phrase “positive enhancement potential” means the retention factor of the target component is close to the closest impurity with different ones of the bracketing solvent strengths for a desired separation, identification or purification. The words “is close to” in this definition means that there is no significant improvement in resolution with gradient separation as compared with an isocratic curve or substantially isocratic curve. Thus, a positive enhancement potential indicates that a difficult separation is improved by an isocratically modified gradient profile or a slowly changing gradient rather than a rapidly changing gradient. In this specification, the word “curve” includes its mathematical meaning i.e. the locus of a point which has one degree of freedom but is not intended to be limited by strict mathematical expressions but to include undefined and irregular variations.

To test for positive or negative enhancement potentials, the retention factors for the target component and for the closest impurity are determined from the TLC runs. A primary component is selected. In this specification, the phrase “primary component” means the target component or closest impurity, whichever has a retention factor closest to the preferred retention factor at a bracketing solvent strength. In this specification, the phrase, “preferred retention factor” means a retention factor selected for efficiency in typical isocratic chromatographic separations. In the preferred embodiment, it is 0.333 and generally chromatographers use a value of approximately 0.333 as a retention factor that permits good separation of a component.

If the retention factors for the primary components in the two TLC runs close, an isocratically modified gradient profile is used. In this specification, the phrase “close retention factors” means retention factors for a component and closest impurity of a sample mixture at significantly different solvent concentrations have close values. In this definition “close values” means the values are 0.2 or less. This definition is also applicable to any two components that are being separated from each other whether one is considered a target component or not.

In using an enhanced isocratically modified gradient profile, the isocratic curve starting solvent strength is determined. The isocratic-gradient profile starting-solvent strength is determined by first determining the solvent strength that corresponds to the preferred retention factor for the primary component and then selecting a lower concentration as the isocratic-gradient profile solvent strength. This starting concentration is selected to keep the time of the isocratic gradient profile or isocratic segment of the enhanced isocratically-modified gradient profile as short as possible but sufficient for a good separation of at least the closest impurity and the target component.

The selected gradient profile is run to the starting concentration of the isocratic gradient profile or isocratic segment and then the isocratic segment is started. The isocratic segment is run to the end point. The end point is the first to occur of any of four events. The first of the four events is the detection of a peak at the start of the isocratic segment. In this event, the end point is close to the next peak that is detected and preferably at the end of the next peak that is detected. The second event is within the ending tolerance of the first peak after the starting tolerance and preferably is the end of the first peak after the starting tolerance. In this specification, the phrase “ending tolerance” means a period of time sufficiently short so that it is not excessively longer than needed to separate the target component and the closest impurity and generally starting with the detection of a peak indicating the elution of the primary component and ending prior to the detection of another peak indicating the elution of the target component or closest impurity that is not the primary component. This definition is also applicable to any two components that are being separated from each other whether one is considered a target component or not.

The third event is the detection of a peak during the isocratic gradient profile or isocratic segment run after the regular isocratic time period. In this specification, the phrase, “regular isocratic time period” means a time period set for a normal isocratic run during which it is expected that a peak of the target component or closest impurity will occur. It is usually twenty percent of the default total time of the chromatographic run but can be longer or shorter depending on the nature of the separation being performed. The fourth event is an operator initiated termination of the isocratic gradient profile or isocratic segment run. In this specification, the phrase “starting tolerance” means a period of time starting when the isocratic gradient profile or isocratic segment solvent strength is reached and ending a time after the isocratic gradient profile or isocratic segment solvent strength is reached that is insignificant in relation to the entire time of the chromatographic run and the time of the isocratic gradient profile or isocratic segment. It is always less than five percent of the time of the regular isocratic time period.

Preferably, a substantial portion of the detection, separation or purification is performed isocratically. While in the preferred embodiment, an isocratic portion of a chromatographic program is utilized, other profiles may be used. For example, if the TLC data indicate that satisfactory purification can be obtained with a linear slowly changing profile, it may be used and save time and solvent by completing the chromatographic run in less time.

From the above description, it can be understood that, the technique of this invention has several advantages, such as for example: (1) it provides superior identification, separation or purification of a desired material; (2) it eliminates or reduces the number of trial runs needed to select a profile; and (3) it is simply implemented with low cost procedures and apparatus.

### BRIEF DESCRIPTION OF THE DRAWINGS

The above noted and other features of the invention will be better understood from the following detailed description, in which:

FIG. 1 is a flow diagram of a chromatographic process in accordance with an embodiment of the invention;

FIG. 2 is a subprogram illustrating a step of the process of FIG. 1;

FIG. 3 is a subprogram illustrating another step of the process of FIG. 1;

FIG. 4 is a subprogram illustrating still another step of the program of FIG. 1; and

FIG. 5 is a block diagram of a chromatographic system incorporating a portion of an embodiment of the invention.

### DETAILED DESCRIPTION

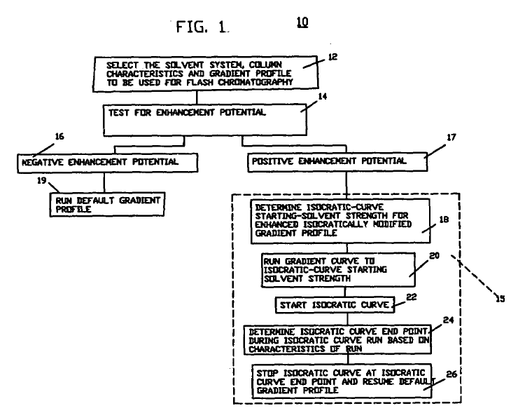

In FIG. 1, there is shown a flow diagram of a process 10 for purifying a component using flash chromatography in accordance with an embodiment of the invention having the step 12 of selecting the solvent system, column characteristics and gradient profile to be used for flash chromatography, the step 14 of determining if an enhanced isocratically modified gradient profile is to be used and the alternate combinations of steps 16 and 19 if the test for enhancement potential is negative and the steps 17 and 15 if the test for enhancement potential is positive. If the test for enhancement potential is negative as shown at 16, the standard gradient profile is run as shown at 19. If the test for enhancement potential is positive as shown at 17, an enhanced modified gradient profile is used as shown at 15.

The step 15 of running an enhanced isocratically modified gradient profile includes the substeps 18 of determining the enhancement isocratic curve starting solvent strength, the step 20 of running a gradient profile to the enhancement isocratic curve starting solvent strength, the step 22 of starting an isocratic gradient profile or isocratic segment, the step 24 of determining the isocratic gradient profile or isocratic segment end point during the isocratically modified gradient profile chromatographic run and the step 26 of stopping the isocratic gradient profile or isocratic segment at the isocratic gradient profile or isocratic segment end point and resuming the standard gradient profile. In this specification, the phrases “isocratic curve” or “isocratic segment”—mean a curve or segment in which the concentration does not significantly change. While the change in concentration that is significant varies with the solvents used and at times with the circumstances, generally the change should not cause a change in retention factor greater than 0.1 and preferably greater than 0.05.

In this process, if an enhanced isocratically modified gradient profile is used, the overall time of the enhanced isocratically modified gradient profile is preferably adjusted to be larger than the regular isocratic gradient profile or isocratic segment time period by the length of the time the isocratic gradient profile or isocratic segment runs. In this specification, the phrases “regular isocratic gradient profile” and “isocratic segment time period” mean a time period set for a normal isocratic run within which it is expected that a peak of the target component or closest impurity will occur. However, the chromatographer may alter this if desirable. This definition is also applicable to any two components that are being separated from each other whether one is considered a target component or not.

In this specification, the phrase “enhanced isocratically modified gradient profile” means a chromatographic gradient profile that has an isocratic curve, isocratic plateau or isocratic segment over a portion that starts before or very early in the elution of a component that is to be identified, separated or purified and continues until just before or sufficiently after the elution of the component that is to be identified, separated or purified for the desired identification, separation or purification. An isocratic gradient profile or isocratic segment is a solvent solution used in liquid chromatography in which the strength of the solution does not vary in a manner that significantly degrades the separation of a target component or target components of the sample during a chromatographic run. The change in separation should not prevent a target component from being clearly identified and commercially purified. In any event the solvent strength should not change by more than ten percent.

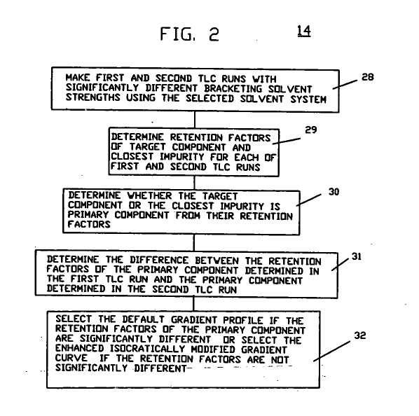

In FIG. 2, there is shown a more detailed flow diagram of the step 14 of determining if the standard gradient profile or the enhanced isocratically modified gradient profile is to be used. This determination is made by determining the amount of change in the retention factor of the primary component with a change in solvent strength.

As shown in FIG. 2, the step 14 includes the substep 28 of making first and second TLC runs with significantly different bracketing solvent strengths using the selected solvent system, the substep 29 of determining the retention factors of the target component and the closest impurity for each of the first and second TLC runs, the substep 30 of determining whether the target component or the closest impurity is the primary component from their respective retention factors, the substep 31 of determining the difference between the retention factors of the primary component determined in the first TLC run and the primary component determined in the second TLC run, and the step 32 of selecting the standard gradient profile if the retention factors of the primary component are significantly different or selecting the enhanced isocratically modified gradient profile if the retention factors are not significantly different. In this specification, the phrase, “significantly different bracketing solvent strengths” means concentrations for TLC runs that are sufficiently different to enable extrapolation between two or more different concentrations to other concentrations with an error of no more than five percent from the actual concentration for all concentrations of interest in a chromatographic run and having at least a ten percent (0.1) difference in concentration. With this technique, if a change in solvent strength does not change the retention factors of the primary component, then using an isocratic gradient does not improve the separation, detection or purification of the target component and an enhanced isocratically modified gradient profile should not be used.

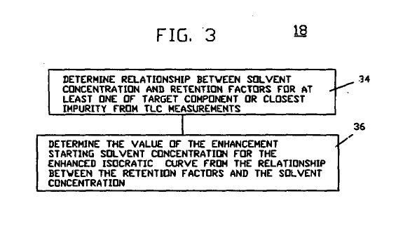

In FIG. 3, there is shown a flow diagram of the step 18 (FIG. 1) of determining isocratic-gradient profile starting-solvent strengths if an enhanced isocratically modified gradient profile is to be used. This process includes the substep 34 of determining the relationship between the solvent concentration and retention factors for at least one of the target component or closest impurity from the TLC measurements and the step 36 of determining the value of the enhancement starting solvent concentration for the isocratic curve or isocratic segment from the relationship between the retention factors and the solvent concentration. This relationship is determined by solvent extrapolation. The phrase “solvent extrapolation” in this specification means estimating the value of a solvent strength as a function of the argument in which the retention factors of the target component and the closest impurity are independent variables and the argument includes these independent variables obtained from two TLC runs. In the preferred embodiment, the argument is a linear first order equation. This definition is also applicable to any two components that are being separated from each other whether one is considered a target component or not.

In the preferred embodiment, the relationship between solvent concentration and retention factors is determined by forming a first order linear equation using the two retention factors determined by the TLC runs as terms and the percentage concentration corresponding to the retraction of factors. This is done by standard gradient profile fitting to arrive at an equation in the form of the percentage concentration equals M multiplied by the retention factor plus a constant C. Using this relationship, the percentage concentration is determined for the preferred retention factor which in the preferred embodiment is 0.333. However retention factors in the vicinity of three generally provide a sufficiently good separation to be used.

If the percentage concentration is calculated to be less than zero, it is set to zero. If it is calculated to be more than 100 percent, it is set to 100 percent. Although in the preferred embodiment, a linear equation is obtained from the two relationships in standard algebraic manner, the information could be stored in tabular form in a computer or graphically used in the same manner. There are many mathematical devices for expressing such a relationship when you have two unknown and two known relationships. For example, the corresponding solvent can be calculated from a simple proportionality based on the linear relationship.

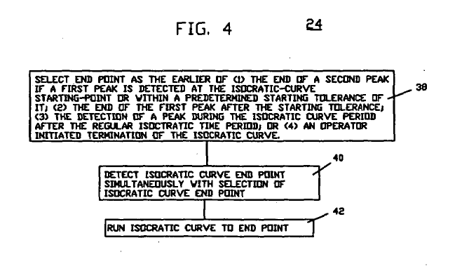

In FIG. 4, there is shown a flow diagram of the step 24 (FIG. 1) of determining the isocratic-curve or segment end point during the isocratic gradient profile run based on characteristics of the isocratic segment. This step includes the substep 38 of selecting the end point, the step 40 of detecting the isocratic curve or isocratic segment end point simultaneously with the selection of the isocratic curve or isocratic segment end point and the step 42 of running the isocratic gradient profile or isocratic segment to the end point. The step 38 of selecting the end point includes selecting the end point as the earlier of: (1) the end of a second peak if a first peak is detected at the isocratic-gradient profile starting-solvent strength or within a predetermined starting tolerance of the isocratic-gradient profile starting-solvent strength detection; (2) the end of the first peak after the starting tolerance; (3) the detection of a peak during the isocratic curve or isocratic segment run after the regular isocratic time period; or (4) an operator initiated termination of the isocratic curve or isocratic segment run. In this specification, the phrase “starting tolerance” means a period of time starting when the isocratic curve or isocratic segment solvent strength is reached and ending at a time after the isocratic curve or isocratic segment solvent strength is reached that is insignificant in relation to the entire time of the chromatographic run and the time of the isocratic curve or isocratic segment. It is always less than five percent of the time of the regular isocratic time period.

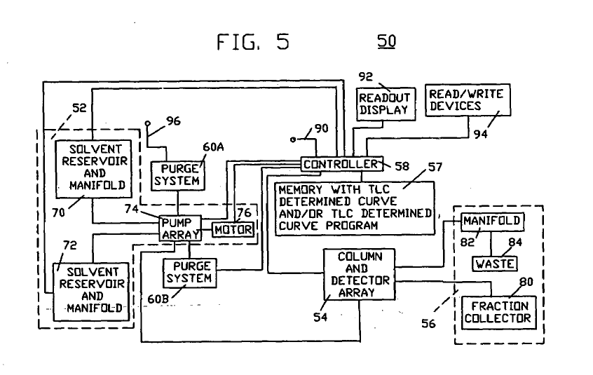

In FIG. 5, there is shown a block diagram of a preparatory liquid chromatographic system 50 having a pumping system 52, a column and detector array 54, a collector system 56, a controller 58 and a purge system 60A and 60B. The controller 58 communicates with a memory 57 storing the TLC determined gradient profile and/or TLC determined gradient profile program as determined in accordance with the description of FIGS. 1-4 above. The pumping system 52 supplies solvent to the column and bands are sensed by a column and detector array 54 under the control of the controller 58. The purge system 60A and 60B communicates with a pump array 74 to purge the pumps and the lines between the pumps and the columns between chromatographic runs. The pump array 74 supplies solvent to the column and detector array 54 from which effluent flows into the collector system 56 under the control of the controller 58. The controller 58 receives signals from detectors in the column and detector array 54 indicating bands of solute and activates the fraction collector system 56 in a manner known in the art. One suitable fraction collection system is the FOXY® 200 fraction collector available from Teledyne Isco, Inc., 4700 Superior Street, Lincoln, Nebr. 68504. A chromatographic system that may include the novel gradient liquid chromatography system is described in greater detail in U.S. Pat. No. 6,427,526, to Davison, et al., the disclosure of which is incorporated herein by reference.

To supply solvent to the pump array 74, the pumping system 52 includes a plurality of solvent reservoirs and manifolds, a first and second of which are indicated at 70 and 72 respectively, a pump array 74 and a motor 76 which is driven under the control of the controller 58 to operate the pump array 74. The controller 58 also controls the valves in the pump array 74 to control the flow of solvent and the formation of gradients as the motor 76 actuates pistons of the reciprocating pumps in the pump array 74 simultaneously to pump solvent from a plurality of pumps in the pump array 74 and to draw solvent from the solvent reservoirs and manifolds such as 70 and 72. Valves in the pump array 74 control the amount of liquid, if any, and the proportions of liquids from different reservoirs in the case of gradient operations that are drawn into the pump and pumped from it. The manifolds communicate with the reservoirs so that a plurality of each of the solvents such as the first and second solvents in the solvent reservoir manifolds 70 and 72 respectively can be drawn into the pump array 74 to permit simultaneous operation of a number of pumps. In some embodiments, the controller 58 may provide a signal on a conductor 90 to cause solvent to flow from a large source of solvent into individual reservoirs that are low on solvent. In some embodiments, the controller 58 stops the run when a low level signal is received or causes a read-out display 92 to indicate a low solvent level.

While in the preferred embodiment, arrays of pumps, columns and detectors are used, any type of pump, column or detector is suitable. A large number of different liquid chromatographic systems are known in the art and to persons of ordinary skill in the art and any such known systems may be adaptable to the invention disclosed herein with routine engineering. While two solvents are disclosed in the embodiment of FIG. 5, only one solvent may be used or more than two solvents may be used. Moreover, instead of an array of pumps with one for every column, only one pump may draw solvent alternately from different reservoirs. Instead of an array of columns, one column at a time may be used.

To process the effluent, the collector system 56 includes a fraction collector 80 to collect solute, a manifold 82 and a waste depository 84 to handle waste from the manifold 82. One or more fraction collectors 80 communicate with the column and detector array 54 to receive the solute from the columns, either with a manifold or not. A manifold 82 may be used to combine solute from more than one column and deposit them together in a single receptacle or each column may deposit solute in its own receptacle or some of the columns each may deposit solute in its own corresponding receptacle and others may combine solute in the same receptacles. The manifold 82 communicates with the column and detector array 54 to channel effluent from each column and deposit it in the waste depository 84. The fraction collector 80 may be any suitable fraction collector such as that disclosed in U.S. Pat. No. 3,418,084 or the above-identified FOXY fraction collector.

With this arrangement, the chromatographic run progresses in the manner discussed above in connection with FIGS. 1-4. However, before using the flash chromatographic equipment of FIG. 5, some preparatory steps are performed. While it is possible to introduce these steps after a chromatographic run is started, this is not desirable and in the preferred embodiment, the preliminary steps are performed before a gradient run. These preliminary steps require the use of TLC but the TLC may be performed with any TLC equipment or techniques and the specific TLC techniques are not part of this invention but only the use of TLC in general. Many sets of commercial equipment, both simple and complicated, are available, some of which are entirely manual and some of which utilize automated techniques.

For example, in one simple technique, only readily available simple equipment is needed. This technique may be broken into five steps, which are: (1) preparing the developing container; (2) preparing the TLC plate; (3) spotting the TLC plate; (4) developing the TLC plate; and (5) visualizing the spots. These five steps are described below:

Firstly, the developing container can be a specially designed commercially obtained chamber or an ordinary jar with a lid or a beaker with a watch glass on the top. Typically, solvent is poured into the container to a depth of just less than 0.5 cm. To aid in the saturation of the TLC chamber with solvent vapors, part of the inside of the beaker may be lined with filter paper. The container is covered, swirled gently, and allowed to stand while a TLC plate is prepared.

Secondly, TLC plates may be 5 cm×10 cm sheets. The more samples that are to be run on a plate, the wider it needs to be. A mark is made on the plate 0.5 cm from the bottom of the plate. A line is drawn across the plate at the 0.5 cm mark. This is the origin for the sample spots. The samples may be identified under the line in pencil. Enough space is left between the samples so that they do not run together.

Thirdly, about one mg of the sample may be dissolved in a few drops of a volatile solvent such as hexanes, ethyl acetate, or methylene chloride. A few drops of solvent is added to obtain the desired concentration for each of the two runs, with the number of drops selected to maintain a significant difference. In each case, the container is swirled until the samples are dissolved. For each of the two runs, the solution is applied to the TLC plate with a 1 microliter microcap or drawn-out pipette.

Fourthly, the prepared TLC plate is placed in the developing beaker, the beaker is covered with the watch glass, and left undisturbed on your bench top. It is run until the solvent is about half a centimeter below the top of the plate. The TLC plate is placed in the developing container. The solvent rises up the TLC plate by capillary action. The plate is removed from the beaker when the solvent is near the top of the plate and a line is marked across the plate at the solvent front with a pencil. The solvent is permitted to evaporate completely from the plate. If the spots are colored, they are simply marked with a pencil.

Fifthly, if samples are colored, they are marked before they fade by circling them lightly with a pencil. If they are not colored, they are visualized with a UV lamp, and marked with a pencil. The retention factors for components of interest in the samples are determined with a ruler alone or specialized optical equipment may be utilized to read the distance that the solvent front has moved on the TLC plate as compared to the distance the component and close impurities have moved. Equipment is available in which the plates are read automatically by scanning, and the retention factors calculated and utilized for purifying or separating or identifying components. However, in the preferred embodiment, the retention factors are utilized as described above with respect to FIGS. 1-4 to determine whether enhancement of a previously programmed chromatographic run is to be performed or not. This is operable on any chromatographic gradient profile such as a linear gradient profile or a stepped gradient profile or any other gradient profile that may be used. The procedures described above are utilized to calculate the solvent strength at which the existing program is interrupted and an enhancement gradient profile inserted. In the preferred embodiment, the enhancement gradient profile is an isocratic curve.

Although a preferred embodiment of the invention has been described with some particularity, it is to be understood that the invention may be practiced other than as specifically described. Accordingly, it is to be understood that, within the scope of the appended claims, the invention may be practiced other than as specifically described.

1. A method of liquid chromatography, comprising the steps of:
programming at least one gradient run with at least one gradient profile;
using TLC to determine whether the at least one gradient profile has a positive enhancement potential or a negative enhancement potential;
following at least one gradient profile having a negative enhancement potential; and
altering at least one gradient profile having a positive enhancement potential to improve the separation between a target component and a closest impurity with an isocratic curve, whereby an enhanced isocratically modified gradient profile is created.

2. The method of claim 1 in which the step of altering the at least one gradient profile having a positive enhancement potential includes the steps of:
determining an isocratic curve starting solvent strength;
running the at least one gradient profile to the isocratic curve starting solvent strength; and
running the isocratic curve.

3. The method of claim 2 in which the step of determining the isocratic-curve starting solvent strength includes the step of determining the relationship between solvent concentrations and retention factors for at least one of a target component and a closest impurity from TLC measurements and the step of determining the value of an enhancement starting solvent concentration for an enhanced isocratic curve from the relationship between the retention factors and the solvent concentrations.

4. A method in accordance with claim 2 further including the steps of:
determining an isocratic curve end point during the running of the isocratic curve based on characteristics of the run; stopping the isocratic run at an isocratic curve end point; and
resuming the gradient profile after stopping the isocratic curve or isocratic segment at the isocratic curve or isocratic segment end point.

5. The method of claim 1 in which the step of using TLC to determine whether the at least one gradient profile has a positive enhancement potential or a negative enhancement potential includes the steps of:
making first and second TLC runs with different bracketing solvent strengths using a selected solvent system;
determining the retention factors of the target component and the closest impurity for each of the first and second TLC runs;
determining whether the target component or the closest impurity is a primary component from the retention factors of the target component and the closest impurity;
determining the difference between the retention factor of the primary component determined in the first TLC run and the retention factor of the primary component determined in the second TLC run; and
determining whether the at least one gradient profile has a negative potential or a positive potential from the difference between the retention factor of the primary component for the first TLC run and the retention factor of the primary component for the second TLC run.

6. A method in accordance with claim 5 in which the gradient profile is identified as having a positive enhancement potential if the retention factors of the primary components are significantly different.

7. A method in accordance with claim 4 in which the step of determining the isocratic curve end point during the isocratic run based on the characteristics of the run comprises the step of selecting a first to occur of an end of a second peak if a first peak is detected at an isocratic-gradient profile starting-point or within a predetermined starting tolerance of it, an end of the first peak after a starting tolerance, a detection of a peak during a isocratic curve or isocratic segment period after the regular isocratic time period and an operator initiated termination of the isocratic curve or isocratic segment.

8. The method of claim 7 wherein the detection of an isocratic curve or isocratic segment end point occurs simultaneously with the selection of the isocratic curve or isocratic segment end point.

9. A method of identifying, separating or purifying a target component using column chromatography, comprising the steps of:
determining a separation effective retention factor;
determining a separation effective solvent strength from the separation effective retention factor;
running a chromatographic gradient profile having an isocratic hold point at a solvent strength lower than the separation effective solvent strength and
using the chromatographic gradient profile in a column chromatographic system for one of identification, separation and purification of a target component.

10. A method in accordance with claim 9 in which the step of determining a separation effective retention factor includes the steps of making two TLC runs made with different solvent strengths and extrapolating retention factors for one of the target component or a closest impurity.

11. A method in accordance with claim 9 wherein the step of determining a separation effective solvent strength from the separation effective retention factor includes the steps of determining at least two retention factors for a primary component and two different solvent strengths; and extrapolating the at least two retention factors and solvent strengths to determine the solvent strength for the retention factor between 2 and 4.

12. (canceled)

13. (canceled)

14. (canceled)

15. (canceled)

16. (canceled)

17. A method of selecting of a standard gradient profile or enhanced isocratically modified gradient profile, comprising the steps of:
making first and second TLC runs with different solvent strengths;
determining retention factors of a target component and a closest impurity for each of the first and second TLC runs;
determining whether the target component or the closest impurity is a primary component from the retention factors of the target component and the closest impurity;
determining the difference between a retention factor of the primary component determined in the first TLC run and a retention factor of the primary component determined in the second TLC run; and
determining whether the at least one gradient run has a negative potential or a positive potential from the difference between the retention factor of the primary component for the first TLC run and the retention factor of the primary component for the second TLC run.

18. A method in accordance with claim 17 in which the at least one gradient run is identified as having a positive enhancement potential if the retention factors of the primary components are significantly different.

19. A method in accordance with claim 17 further including the step of determining an isocratic curve end point during the isocratic gradient profile run based on the characteristics of the run wherein the isocratic curve end point is a first to occur of an end of a second peak if a first peak is detected at an isocratic-gradient profile starting-point or within a predetermined starting tolerance of it, an end of the first peak after a starting tolerance, a detection of a peak during an isocratic gradient profile period after the regular isocratic time period and an operator initiated termination of the isocratic gradient profile or isocratic segment.

20. The method of claim 9 in which the step of determining a separation effective solvent strength includes the steps of:
determining a first retention factor for a chromatographic sample at a first solvent strength;
determining a second retention factor of the chromatographic sample at a second solvent strength;
determining an isocratic solvent strength by solvent extrapolation from the first and second retention factors and at least one solvent strength wherein a separation between a first peak and a second peak during a gradient chromatographic run increases; and
inserting an isocratic gradient profile when the isocratic solvent strength is reached during the chromatographic run.

21. A method in accordance with claim 20 wherein the step of inserting an isocratic gradient profile when the isocratic solvent strength is reached during the chromatographic run includes the step of selecting a gradient chromatographic gradient profile having an isocratic hold point at a solvent strength corresponding to a retention factor lower than a preferred retention factor;
making first and second TLC runs with different bracketing solvent strengths using a selected solvent system;
determining retention factors of the first and second spots for each of the first and second TLC runs; and
determining which of the first and second spots is a primary component from the retention factors of the two TLC runs.

22. The method of claim 9 in which the step of running a chromatographic gradient profile includes the steps of:
starting an isocratic segment before elution of the first peak;
determining an isocratic segment end point during an isocratic gradient profile run based on characteristics of the run; and
terminating an isocratic gradient profile at an isocratic curve end point, whereby a separation between a first peak and a second peak during a gradient chromatographic run increases.

23. A method in accordance with claim 22 in which the step of determining an isocratic curve end point during an isocratic gradient profile run based on the characteristics of the run comprises the step of selecting a first to occur of an end of a second peak if a first peak is detected at an isocratic-gradient profile starting-point or within a predetermined starting tolerance of it, an end of the first peak after a starting tolerance, a detection of a peak during an isocratic gradient profile period after a regular isocratic time period and an operator initiated termination of the isocratic gradient profile, wherein the detection of the isocratic curve end point occurs simultaneously with the selection of the isocratic curve end point; and
the step of determining the isocratic end point during the isocratic run based on the characteristics of the run comprises the step of selecting the first to occur of the end of a second peak if a first peak is detected at the isocratic-gradient profile starting-point or within a predetermined starting tolerance of it, the end of the first peak after the starting tolerance, the detection of a peak during the isocratic gradient profile period after the regular isocratic time period and an operator initiated termination of the isocratic gradient profile.

24. (canceled)

25. (canceled)

26. A method of determining a solvent starting concentration for an isocratic segment of a gradient run, comprising the steps of:
determining retention factors and solvent concentrations for at least one of a target component and a closest impurity;
determining the relationship between the solvent concentrations and the retention factors for at least one of a target component and a closest impurity from TLC measurements; and
determining the value of an enhancement solvent concentration for an enhanced isocratic gradient profile or isocratic segment from the relationship between the retention factors and the solvent concentrations.

27. A method in accordance with claim 22 further including the steps of:
selecting a first to occur of: an end of a second peak if a first peak is detected at an isocratic-gradient profile starting-point or within a predetermined starting tolerance of it; an end of the first peak after the staffing tolerance; or a detection of a peak during an isocratic segment period after a regular isocratic time period and an operator initiated termination of the isocratic gradient profile or isocratic segment, wherein an end of an isocratic segment inserted into a chromatographic gradient run during running of the isocratic segment based on the characteristics of the run is determined whereby a detection of the isocratic segment end point occurs simultaneously with the selection of the isocratic segment end point: and
determining an isocratic segment end point during an isocratic segment run based on characteristics of the run; stopping the isocratic segment at the isocratic segment end point; and resuming the gradient run after stopping the isocratic segment at the isocratic segment end point.

28. (canceled)

29. (canceled)

30. A method in accordance with claim 9 wherein the step of determining a separation effective retention factor includes the steps of:
determining the relationship between solvent concentrations and retention factors for at least one of a target component and a closest impurity from TLC measurements;
determining the value of an enhancement starting solvent concentration for an enhanced isocratic curve from the relationship between the retention factors and the solvent concentrations.
selecting a chromatographic gradient profile;
running the chromatographic gradient profile to the enhancement starting solvent concentration;
starting an isocratic hold point at a retention factor lower than the separation effective retention factor corresponding to a preferred retention factor; and
using the chromatographic gradient profile in a column chromatographic system for one of identification, separation and purification of a target component.

31. Apparatus for performing liquid chromatography, comprising:
a microcontroller;
first and second solvent reservoirs;
a pumping system,
a mixing system in communications with the first and second solvent reservoirs and pumping system whereby the first and second solvents may be mixed and pumped by the pumping system in proportions controlled by the microcontroller;
a chromatographic column system whereby components of sample mixtures are separated;
a detector system in communication with the microcontroller and chromatographic column system whereby spots may be detected and their detection communicated to the microcontroller;
said microcontroller including at least one program for controlling the solvent mixture pumped from the first and second solvent reservoirs by the pumping system and mixed by the mixing system, at least one gradient elution profile and at least one isocratic segment whereby gradient elution profiles may be supplied to the microprocessor to control gradient runs and isocratic segments may be inserted into the gradient elution profiles;
a microcontroller input device in communication with the microcontroller wherein data obtained by TLC may be entered into the microcontroller; and
said microcontroller including a program for inserting an isocratic program into a profile when the gradient profile reaches an isocratic solvent strength.
